(19) United States
(12) Patent Application Publication
(10) Pub. No.: US 2025/0245736 A1
(43) Pub. Date: Jul. 31, 2025

(54) SYSTEMS AND METHODS FOR BORROWED BANKING ACCESS

(71) Applicant: Wells Fargo Bank, N.A., San Francisco, CA (US)

(72) Inventors: Poonam Chawla, San Francisco, CA (US); Darlene Goins, San Francisco, CA (US)

(73) Assignee: Wells Fargo Bank, N.A., San Francisco, CA (US)

(21) Appl. No.: 18/423,688

(22) Filed: Jan. 26, 2024

(51) Int. Cl. G06Q 40/02; G06Q 20/40

(52) U.S. Cl. CPC G06Q 40/02; G06Q 20/401

(57) ABSTRACT

A computing system including one or more processing circuits configured to receive a request from a first user device of a first user associated with a first account to create an allocated user portion within the first account, create the allocated user portion based on the request from the first user device, generate credentials for a second user configured to allow the second user to perform one or more actions associated with allocated funds of the allocated user portion within the first account and to disallow the second user from performing actions associated with non-allocated funds within the first account that are outside of the allocated user portion, and transmit the credentials to one of the first user device of the first user or a second user device of the second user.

### TECHNICAL FIELD

The present disclosure relates to systems and methods for allowing for unbanked individuals to borrow banking access from banked individuals.

### BACKGROUND

Unbanked or underbanked individuals (e.g., individuals having few to no accounts associated with financial institutions) are unbanked or underbanked for a variety of reasons. For example, some individuals may wish to remain anonymous to financial institutions, or they may not have sufficient credit or other financial history to open certain accounts. In any case, there are various scenarios where unbanked individuals could benefit from using services provided by financial institutions but are unable or unwilling to create their own accounts that would give them access to such services.

### SUMMARY

One embodiment relates to a computing system comprising one or more processing circuits including one or more processors and one or more memories having instructions stored thereon that, when executed, cause the one or more processing circuits to receive a request from a first user device of a first user associated with a first account of the first user held by a provider to create an allocated user portion within the first account. The instructions, when executed, further cause the one or more processing circuits to create the allocated user portion within the first account based on the request from the first user device. The instructions, when executed, further cause the one or more processing circuits to generate credentials for a second user configured to allow the second user to perform one or more actions associated with allocated funds of the allocated user portion within the first account and to disallow the second user from performing actions associated with non-allocated funds within the first account that are outside of the allocated user portion. The instructions, when executed, further cause the one or more processing circuits to transmit the credentials to one of the first user device of the first user or a second user device of the second user.

Another embodiment relates to a computing system comprising one or more processing circuits including one or more processors and one or more memories having instructions stored thereon that, when executed, cause the one or more processing circuits to create an allocated user portion within a first account of a first user held by a provider. The instructions, when executed, further cause the one or more processing circuits to generate credentials for a second user configured to allow the second user to perform one or more actions associated with allocated funds of the allocated user portion within the first account and to disallow the second user from performing actions associated with non-allocated funds within the first account that are outside of the allocated user portion. The instructions, when executed, further cause the one or more processing circuits to cause the one or more actions associated with the allocated funds to be performed based on receiving the credentials from the second user.

Still another embodiment relates to a method. The method comprises creating, by a provider computing system associated with a provider, an allocated user portion within a first account of a first user held by the provider. The method further comprises generating, by the provider computing system, credentials for a second user configured to allow the second user to perform one or more actions associated with allocated funds of the allocated user portion within the first account while preventing the second user from performing actions associated with non-allocated funds within the first account that are outside of the allocated user portion. The method further comprises causing, by the provider computing system, the one or more actions associated with the allocated funds to be performed based on receiving the credentials from the second user.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the disclosure may be combined with one or more features of a different aspect of the disclosure. Moreover, additional features may be recognized in certain embodiments and/or implementations that may not be present in all embodiments or implementations.

### BRIEF DESCRIPTION OF THE FIGURES

FIG. 1 is a block diagram of a computing environment for allowing non-banked or underbanked individuals to borrow banking access from banked individuals, according to an example embodiment.

FIG. 2 is a flow diagram of a method for creating and enabling use of an allocated user portion for a non-account holder within an account of an account holder, according to an example embodiment.

FIG. 3 is a graphical user interface providing an allocated user portion creation request page, according to an example embodiment.

FIG. 4 is a graphical user interface providing an allocated user portion access page, according to an example embodiment.

FIG. 5 is a flow diagram of a method for tracking and reporting tracked actions associated with an allocated user portion, according to an example embodiment.

### DETAILED DESCRIPTION

Referring generally to the figures, systems and methods for allowing non-banked or underbanked individuals to borrow banking access from banked individuals are disclosed. For example, the systems and methods described herein allow for an account holder at a provider institution to create a partitioned “allocated user portion” within their account that is accessible by a non-account holder (e.g., via online access credentials or an allocated user portion payment card), while the remainder of the account holder's account remains inaccessible to the non-account holder. In some instances, the non-account holder is provided with online access to the allocated user portion and is able to deposit funds into the allocated user portion, withdraw funds from the allocated user portion, set up recurring bill payments from the allocated user portion, and/or perform various other account functionalities with respect to the allocated user portion.

Beneficially, the allocated user portion described herein allows for the account holder (e.g., a banked person) to allow the non-account holder (e.g., an unbanked person) to borrow the functionality of the account holder's account to conduct online transactions, set up online scheduled bill payments, and perform other online account functionalities with respect to the allocated user portion that have traditionally required a bank account without the non-account holder having to open an account of his or her own with a provider institution. Further, unlike simply providing the non-account holder with a payment card linked to the account holder's account generally (e.g., one that has a transaction limit and pulls funds from the account holder's account generally), the partitioned allocated user portion described herein allows the non-account holder to make deposits into the allocated user portion that can later be withdrawn or used in online transactions as needed without providing the non-account holder with access to other funds within the account holder's account. For example, in some instances, the non-account holder is provided with online access credentials that allow the non-account holder to sign into an online portal to view the balance of the allocated user portion, make deposits into the allocated user portion, set up bill payments from the allocated user portion, transfer funds into or out of the allocated user portion, and/or perform various other online functionalities.

Additionally, the allocated user portion beneficially allows for the provider institution to track transactions (e.g., deposits, withdrawals, payments) conducted using the allocated user portion and to later report the allocated user portion transaction history to one or more credit bureaus at the request of the non-account holder. Accordingly, the non-account holder is allowed to establish and build a credit history with the provider institution before having a formal relationship with the provider institution.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

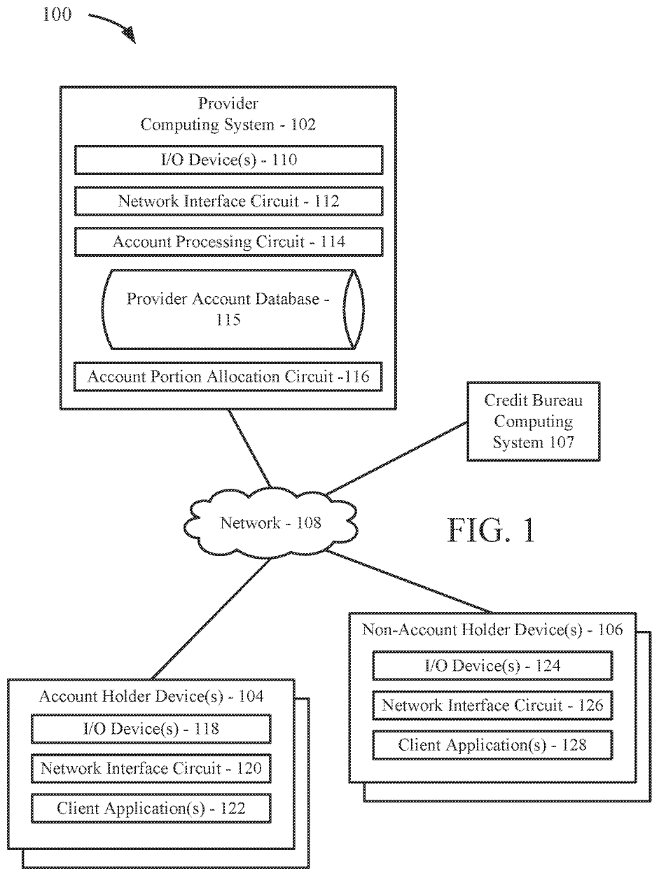

FIG. 1 is a diagram of a computing environment 100 for allowing non-banked or underbanked individuals to borrow banking access from banked individuals, according to an example embodiment. As shown, the computing environment 100 includes a provider computing system 102, one or more account holder devices 104, one or more non-account holder devices 106, and a credit bureau computing system 107. The provider computing system 102, the one or more account holder devices 104, and the one or more non-account holder devices 106, and the credit bureau computing system 107 are in communication with each other and are connected by a network 108.

The provider computing system 102 is owned by, associated with, or otherwise operated by a provider institution (e.g., a bank or other financial institution) that maintains one or more accounts held by various customers (e.g., the account holder associated with the account holder device 104), such as demand deposit accounts, credit card accounts, receivables accounts, and so on.

In some instances, the provider computing system 102 may comprise one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the provider computing system 102 may comprise and/or have various other devices communicably coupled thereto, such as, for example, desktop or laptop computers (e.g., tablet computers), smartphones, wearable devices (e.g., smartwatches), and/or other suitable devices.

In some embodiments, the provider computing system 102 includes one or more I/O devices 110, a network interface circuit 112, an account processing circuit 114, a provider account database 115, and an account portion allocation circuit 116. The one or more I/O devices 110 are configured to receive inputs from and display information to a user. While the term “I/O” is used, it should be understood that the I/O devices 110 may be input-only devices, output-only devices, and/or a combination of input and output devices.

In some instances, the network interface circuit 112 includes, for example, program logic that connects the provider computing system 102 to the network 108. For example, in some instances, the program logic interfaces with one or more transceivers (e.g., Bluetooth, Wi-Fi, or any other suitable communication transceivers) to enable connection with the network 108. The network interface circuit 112 facilitates secure communications between the provider computing system 102 and each of the account holder device(s) 104, the non-account holder device(s) 106, and the credit bureau computing system 107. The network interface circuit 112 also facilitates communication with other entities, such as other banks, settlement systems, and so on. The network interface circuit 112 further includes user interface program logic configured to generate and present web pages to users accessing the provider computing system 102 over the network 108.

The account processing circuit 114 is structured or configured to perform a variety of functionalities or operations to enable and monitor various customer activities (e.g., account processing, product registration processing, account monitoring, etc.) in connection with customer account information stored within a provider account database 115. In some instances, the account processing circuit 114 performs various functionalities to enable account opening and/or closing actions, account withdrawals and deposits (e.g., account credits and debits to checking and savings accounts), various customer account tracking activities, and/or a variety of other services associated with and/or provided by the provider.

The provider account database 115 is structured or configured to retrievably store customer account information associated with various customer accounts held or otherwise maintained by the provider institution on behalf of its customers. In some instances, the customer account information includes customer information, account information, and payment card information pertaining to a given customer account and associated payment card.

For example, in some instances, the customer information may include a name, a phone number, an e-mail address, a physical address, etc. of the customer associated with the customer account. In some instances, the account information may include information pertaining to the type and corresponding capabilities of the given account, an online access status associated with the customer account (e.g., an indication of whether the customer has been registered for online access to the customer account), online access information associated with the customer account (e.g., a username, a password, a list of customer devices authorized for online access to the customer account), etc. associated with the customer account. In some instances, the payment card information may include a payment card number, an expiration date, a card verification value (CVV) number, a PIN status (e.g., an indication of whether the payment has an associated PIN), a PIN (e.g., if the PIN has been set), etc. associated with the payment card.

In some instances, the account information may further include allocated user portion information associated with an allocated user portion. As used herein, the term “allocated user portion” is utilized to signify a partitioned portion of the account holder account that is designated for use by the non-account holder and/or by the account holder on the non-account holder's behalf. The funds within the allocated user portion can be made available to the non-account holder via credentials provided to the non-account holder (e.g., a personal identification number, online account access credentials), while the funds within the account holder account that are not allocated to the allocated user portion remain inaccessible to the non-account holder.

In some instances, the allocated user portion information may include information pertaining to an allocated user portion limit, an allocated user portion balance, temporary credentials (e.g., a temporary username, a temporary password, a temporary personal identification number (PIN)) associated with the allocated user portion, one or more capabilities associated with the allocated user portion that a non-account holder has access to via the temporary credentials (e.g., ATM deposits, access to online bill-pay features, creating a stored value card associated with the allocated user portion, accessing the allocated user portion via a mobile wallet), or any other desired information pertaining to the allocated user portion.

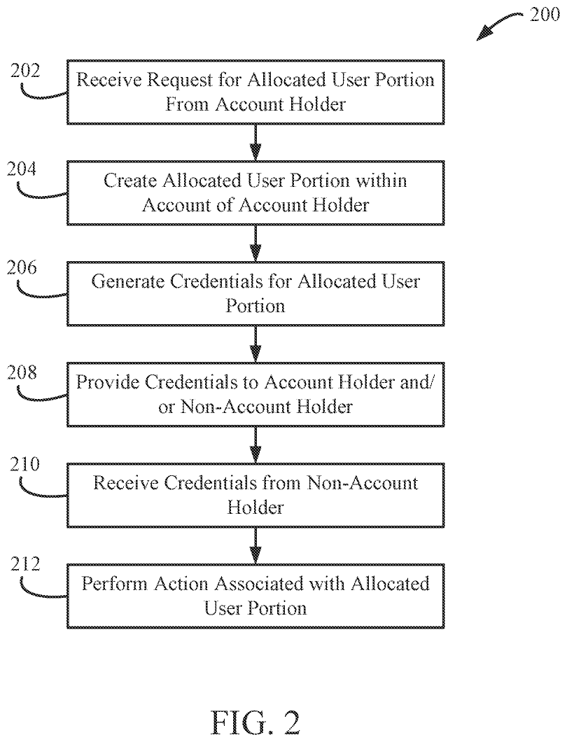

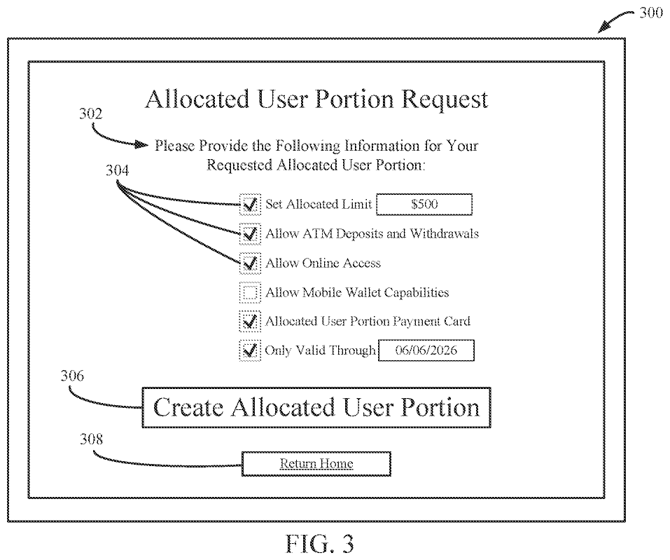

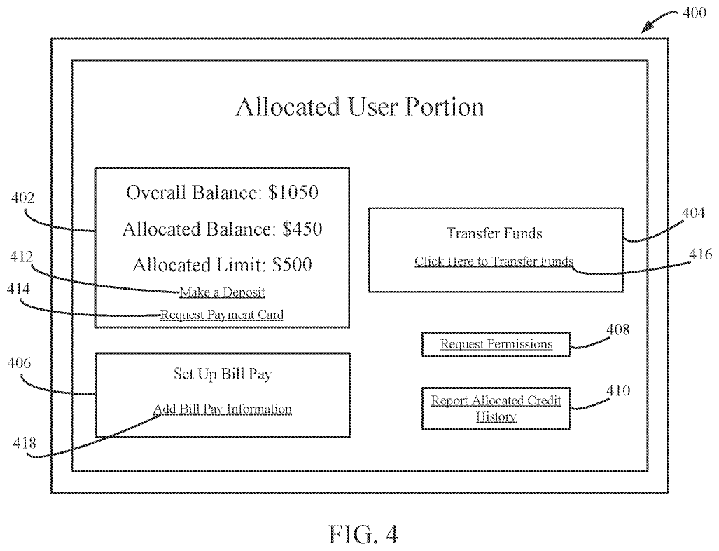

The account portion allocation circuit 116 is structured to enable various functionalities described herein. For example, in some instances, the account portion allocation circuit 116 is structured to create and enable use of an allocated user portion, as described in detail below, with respect to FIG. 2. In some instances, the account portion allocation circuit 116 is further structured to track and report various tracked actions associated with an allocated user portion, as described in detail below, with respect to FIG. 4. In some instances, the account portion allocation circuit 116 is further structured to generate various user interfaces associated with accessing, managing, and/or performing various actions with respect to the allocated user portion, as will be described in detail below, with respect to FIGS. 3 and 4.

The account holder device 104 is owned, operated, controlled, managed, and/or otherwise associated with an account holder (e.g., a customer of the provider institution). In some embodiments, the account holder device 104 may be or may comprise, for example, a desktop or laptop computer (e.g. a tablet computer), a smartphone, a wearable device (e.g., a smartwatch), a personal digital assistant, and/or any other suitable computing device.

In some embodiments, the account holder device 104 includes one or more I/O devices 118, a network interface circuit 120, and one or more client applications 122. While the term “I/O” is used, it should be understood that the I/O devices 118 may be input-only devices, output-only devices, and/or a combination of input and output devices.

In some instances, the I/O devices 118 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 118 further comprise one or more user interfaces (devices or components that interface with the customer), which may include one or more biometric sensors (such as a fingerprint reader, a heart monitor that detects cardiovascular signals, face scanner, an iris scanner, etc.).

The network interface circuit 120 includes, for example, program logic and various devices (e.g., transceivers, etc.) that connect the account holder device 104 to the network 108. For example, in some instances, the program logic interfaces with one or more transceivers (e.g., Bluetooth, Wi-Fi, or any other suitable communication transceivers) to enable connection with the network 108. The network interface circuit 120 facilitates secure communications between the account holder device 104 and each of the provider computing system 102, any other account holder devices 104, and the non-account holder device 106. The network interface circuit 120 also facilitates communication with other entities, such as other banks, settlement systems, and so on.

In some embodiments, the account holder device 104 stores in computer memory, and executes (“runs”) using one or more processors, various client applications 122, such as an Internet browser presenting websites, text messaging applications, and/or applications provided or authorized by entities implementing or administering any of the computing systems in environment 100.

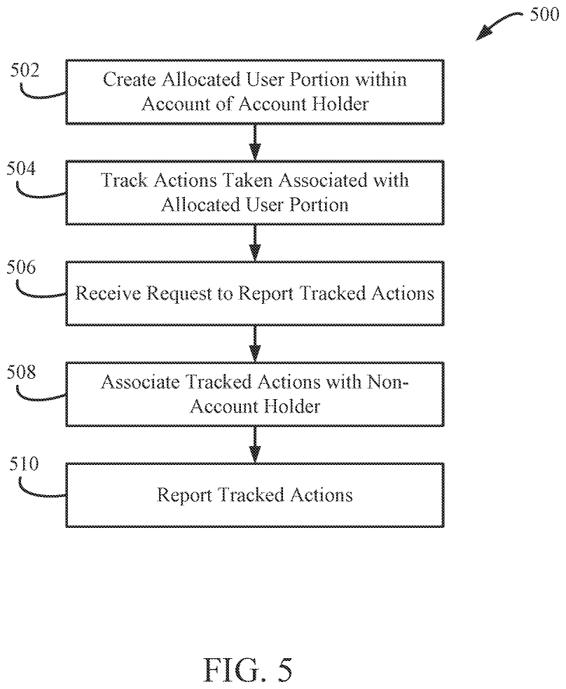

For example, in some instances, the client applications 122 comprise a provider client application (e.g., a financial institution banking application) provided by and at least partly supported by the provider computing system 102. For example, in some instances, the client application 122 coupled to the provider computing system 102 enables the account holder to perform various customer activities (e.g., account management, account opening and/or closing actions, account withdrawals and deposits, account PIN setting, etc.) and/or perform various transactions (e.g., the account holder making a mortgage payment, the account holder sending funds to a recipient, the account holder receiving funds from a sender, etc.) associated with one or more financial accounts of the account holder held at a provider institution associated with the provider computing system 102 (e.g., account opening and closing operations, fund transfers, etc.). In some instances, the provider client application further enables the account holder to perform various functionalities described herein (e.g., with respect to FIGS. 2 and 5) to request, create, and/or perform various transaction and account management actions associated with an allocated user portion of one or more of their accounts held by the provider.

The non-account holder device 106 is owned, operated, controlled, managed, and/or otherwise associated with a non-account holder (e.g., an individual who is not a customer of the provider institution). In some embodiments, the non-account holder device 106 may be or may comprise, for example, a desktop or laptop computer (e.g. a tablet computer), a smartphone, a wearable device (e.g., a smartwatch), a personal digital assistant, and/or any other suitable computing device.

In some embodiments, the non-account holder device 106 similarly includes one or more I/O devices 124, a network interface circuit 126, and one or more client applications 128. In some instances, the I/O devices 124 and the network interface circuit 126 are the same as or similar to the I/O devices 118 and the network interface circuit 120 described above, with respect to the account holder device 104. As such, the description of the I/O devices 118 and the network interface circuit 120 above is similarly applicable to the I/O devices 124 and the network interface circuit 126.

In some embodiments, the non-account holder device 106 stores in computer memory, and executes (“runs”) using one or more processors, various client applications 128, such as an Internet browser presenting websites, text messaging applications, and/or applications provided or authorized by entities implementing or administering any of the computing systems in environment 100.

For example, in some instances, the client applications 128 similarly comprise a provider client application (e.g., a financial institution banking application) provided by and at least partly supported by the provider computing system 102. For example, in some instances, the provider client application enables the non-account holder to perform various functionalities described herein (e.g., with respect to FIGS. 2 and 5) to perform various transaction and account management actions associated with an allocated user portion associated with an account of the account holder held by the provider.

The credit bureau computing system 107 is controlled by, managed by, owned by, and/or otherwise associated with a credit bureau entity (e.g., Experian, Equifax, TransUnion) configured to maintain, track, and/or otherwise receive, store, and/or provide various credit reporting information to and/or from various entities to establish one or more credit worthiness indicators (e.g., a FICO credit score) for various individuals.

In some embodiments, the credit bureau computing system 107 may, for example, comprise one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures.

Although not specifically shown, it will be appreciated that the credit bureau computing system 107 may include a network interface circuit, various additional databases (e.g., similar to the provider account database 115), an account processing circuit (e.g., similar to the account processing circuit 114), and/or other circuits in the same or similar manner to the other components of environment 100.

With an example structure of the environment 100 being described above, example processes performable by the environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring now to FIG. 2, a flow diagram of a method 200 for creating and enabling use of an allocated user portion for a non-account holder within an account of an account holder is shown, according to an example embodiment. In some instances, the method 200 is performed or otherwise executed using various components of the computing environment 100.

As shown, the method 200 begins with the provider computing system 102 receiving a request for an allocated user portion to be created from the account holder, at step 202. For example, the account holder can request the allocated user portion via one of the client applications 122 on the account holder device 104. The request for the allocated user portion can include a variety of information regarding the allocated user portion to be created.

For example, referring to FIG. 3, a graphical user interface 300 is shown, according to an example embodiment. In some instances, the graphical user interface 300 is generated by the provider computing system 102 and provided to the account holder device 104 as part of an online portal (e.g., via one of the client applications 122). As illustrated, the graphical user interface 300 includes a prompt 302, a plurality of account option selection boxes 304, an allocated user portion creation button 306, and a return button 308. In some instances, the prompt 302 instructs the account holder to provide various information pertaining to the allocated user portion to be created.

The account option selection boxes 304 can be used by the account holder to indicate one or more of a variety of capabilities the account holder wishes to allow for the non-account holder to have with respect the allocated user portion. For examples, the account option selection boxes 304 can include an allocated limit option configured to allow the account holder to place a limit on the amount of funds that can be placed within the allocated user portion. The account option selection boxes 304 can further include an option to allow or disallow the non-account holder to conduct automated teller machine (ATM) deposits and withdrawals using the allocated account portion. The account option selection boxes 304 can further include an option to allow or disallow the non-account holder online access to the allocated account portion. The account option selection boxes 304 can further include an option to allow or disallow the non-account holder access to mobile wallet capabilities with regard to the allocated account portion.

The account option selection boxes 304 can further include an option to provide or otherwise allow the non-account holder to request and receive an allocated user portion (AUP) payment card (e.g., a physical payment card and/or a virtual payment card) linked to the allocated user portion, as will be described below. For example, in some instances, the account holder can request that the AUP payment card configured to draw from the allocated user portion be provided to the non-account holder. In some instances, a variety of capabilities may similarly be selectively allowed or disallowed by the account holder with respect to the non-account holder's use of the AUP payment card associated with the allocated user portion. For example, the account holder may set a particular spending limit (e.g., a daily limit, a weekly limit), a transaction number limit (e.g., a daily limit, a weekly limit), etc. In some instances, the AUP payment card can be a stored value card that is configured to receive and store monetary value from the allocated user portion.

The account option selection boxes 304 can further include an allocated user portion time limit through which the allocated user portion and/or credentials provided to the non-account holder will remain valid and/or functional. In some instances, the time limit can be a date in the future. In some other instances, the time limit can be a period of time (e.g., two weeks, a month, a year). In some instances, once the allocated user portion time limit expires, the provider computing system 102 removes the allocated user portion from the account holder account, such that there is no longer a separately partitioned set of funds within the account holder account. In some other instances, once the allocated user portion time limit expires, the allocated user portion is not removed from the account holder account, but the credentials provided to the non-account holder for accessing the allocated user portion are deactivated, such that the non-account holder can no longer access the allocated user portion (e.g., the funds stored within the allocated user portion).

Referring again to FIG. 2, upon receiving the request for the allocated user portion to be created, the provider computing system 102 then creates the allocated user portion within the account of the account holder, at step 204. For example, in some instances, the account portion allocation circuit 116 of the provider computing system 102 can create the allocated user portion by creating a partitioned portion of the account holder account that is designated for use by the non-account holder. The account portion allocation circuit 116 can then apply the various capabilities indicated by the account holder to the allocated user portion by creating and storing various permissions corresponding to the indicated capabilities within the provider account database 115 and associated with the allocated user portion of the account holder account.

In some instances, once the allocated user portion is created, the account holder can selectively deposit funds into, withdraw funds from, and/or transfer funds between the allocated user portion and the remaining portion of the account holder account via a banking application (e.g., one of the client applications 122) on the account holder device 104. In some instances, the account holder can further transfer funds from the allocated user portion to one or more merchants (e.g., perform transactions and/or set up a recurring bill pay schedule) on the non-account holder's behalf (e.g., using the banking application) in the case that the non-account holder does not wish to perform the transactions and/or set up the recurring bill pay schedule personally. Accordingly, in some instances, the account holder maintains full control of the entire account holder account, including both the allocated user portion and the remaining portion of the account holder account, while the non-account holder is given limited control over only the allocated user portion, as described herein.

The provider computing system 102 then generates credentials for the allocated user portion, at step 206, and provides the credentials to the account holder and/or the non-account holder, at step 208. For example, in some instances, the account holder specifies that the non-account holder can access various online account functionality with respect to the allocated user portion. Accordingly, upon creating the allocated user portion, the account portion allocation circuit 116 can further generate online access credentials for the non-account holder to utilize to access the online account functionality (e.g., via a banking application on the non-account holder device 106). The provider computing system 102 can then transmit or otherwise provide the generated credentials to the account holder (e.g., the account holder device 104) and/or the non-account holder (e.g., the non-account holder device 106).

In some instances, the account holder can specify that the non-account holder is only allowed online access to the allocated user portion for a predetermined period of time (e.g., a week, a month, several months, a year). Accordingly, in some instances, the online access credentials generated and provided to the non-account holder are temporary (e.g., only valid for the predetermined period of time). That is, upon expiration of the predetermined period of time, the provider computing system 102 will no longer accept the temporary online access credentials originally provided to the non-account holder, and thus the non-account holder will no longer have online access to the allocated user portion or the functionality thereof described herein. In some instances, the credentials generated and provided to the non-account holder can further include a personal identification number (PIN) that the non-account holder can utilize to make a deposit (e.g., via an ATM) from the allocated user portion.

Once the credentials have been provided to the account holder and/or the non-account holder, the provider computing system 102 then receives the credentials from the non-account holder, at step 210, and allows the non-account holder to perform one or more actions associated with the allocated user portion, at step 212. That is, upon receiving the credentials from the non-account holder (e.g., via the non-account holder device 106, the provider computing system 102 allows the non-account holder to perform various actions associated with allocated funds of the allocated user portion within the account holder account, while preventing the non-account holder from performing actions associated with non-allocated funds within the account holder account that are outside of the allocated user portion.

Accordingly, the method 200 allows for the account holder to create an allocated user portion within the account holder account for use by the non-account holder. In some instances, the account holder is allowed to create multiple allocated user portions within the account holder account for use by multiple non-account holders. For example, as an example, in the case of multiple allocated user portions, the account holder account can include a first allocated user portion for a first allocated user portion, a second allocated user portion for a second allocated user portion, and a third allocated user portion for a third allocated user portion, and each of the first, second, and third allocated user portions (e.g., the funds and various functionalities described above) can be accessible to the corresponding first, second, and third non-account holders. In this example, the account holder would still maintain total control over the account holder account, including the first, second, and third allocated user portions, as well as the non-allocated user portion of the account holder account.

For example, referring to FIG. 4, a graphical user interface 400 is shown, according to an example embodiment. In some instances, the graphical user interface 400 is generated by the provider computing system 102 and provided to the non-account holder device 106 as part of an online portal (e.g., via one of the client applications 128). As illustrated, the graphical user interface 400 includes a balance widget 402, a fund transfer widget 404, a bill pay widget 406, a permissions request button 408, and a credit report button 410.

The balance widget 402 includes various balance-related information and allows for various balance-related functionality. For example, in some instances, as shown in FIG. 4, the balance widget 402 includes an overall balance of the account holder account, an allocated balance of the allocated user portion of the account holder account, and an allocated limit indicating a limit of funds that can be stored within the allocated user portion. In some other instances, the balance widget 402 includes the allocated balance, but the non-account holder is prevented from seeing the overall balance of the account holder account.

In some instances, the balance widget 402 includes a deposit link 412 configured to allow the non-account holder to make a deposit into the allocated user portion of the account holder account. For example, in some instances, the deposit link 412 is configured to navigate the non-account holder to a separate page where the non-account holder can make a mobile deposit (e.g., a mobile deposit of a check via a camera of the non-account holder device 106). In some instances, the deposit link 412 is configured to navigate the non-account holder to a separate page including various information for how to deposit money into the allocated user portion (e.g., a routing number, wire transfer information).

In some instances, the balance widget 402 further includes a payment card request link 414 configured to allow the non-account holder to request an allocated user portion (AUP) payment card that is linked to the allocated user portion. In some instances, the AUP payment card is a physical payment card and/or a virtual payment card (e.g., to be stored in a mobile wallet) that can be used by the non-account holder to pay for transactions using funds within the allocated user portion. For example, if the allocated user has granted permission, upon the provider computing system 102 receiving the AUP payment card request from the non-account holder device 106, the provider institution creates the AUP payment card (e.g., the physical payment card and/or a virtual payment card) and sends the AUP payment card to the non-account holder (e.g., physically mailing the physical AUP payment card and/or transmitting the virtual AUP payment card). The provider computing system 102 then stores various payment card information (e.g., a card number, a card verification value (CVV) number, an expiration date) and restrictions associated with the AUP payment card within the provider account database 115. For example, the restrictions can include only allowing the AUP payment card to pull funds from the allocated user portion, as well as any other restrictions placed on the AUP payment card by the account holder, such as a limit on the number of transactions over a given timeframe (e.g., a daily transaction limit) or a transaction amount limit over a given timeframe (e.g., a daily transaction amount limit).

In some instances, the non-account holder is also provided with a personal identification number (PIN) associated with the AUP payment card that is generated by the provider computing system 102 and stored within the provider account database 115. As such, the non-account holder is allowed to make cash deposits into and/or perform various other account management functions relating to the allocated user portion via an automated teller machine (ATM) and/or at a branch of the provider institution using the AUP payment card and the PIN.

In some other instances, instead of allowing the non-account holder to use the AUP payment card to conduct transactions to and/or from the allocated user portion directly (e.g., similar to a debit card payment and/or deposit), the AUP payment card can instead function as a stored value card onto which the non-account holder can transfer funds from the allocated user portion to be later used to conduct transactions.

In some instances, the balance widget 402 can further include various additional information and/or functionality. For example, the balance widget 402 can further include an allocated user portion limit indicating a maximum amount of funds that can be placed into the allocated user portion (e.g., $1,000). In some instances, the balance widget 402 can further include a limit increase request link (e.g., similar to the deposit link 412) configured to navigate the non-account holder to a limit increase request page where the non-account holder can specify the new limit they wish to request.

The fund transfer widget 404 includes a fund transfer link 416 configured to allow the non-account holder to transfer funds from the allocated user portion to various destinations. For example, in some instances, the fund transfer link 416 is configured to navigate the non-account holder to a fund transfer page where the non-account holder can specify an amount of funds to be transferred and a destination for the funds. In some instances, the destination provided by the non-account holder can be a routing number, a bank account number, a transfer service identifier (e.g., a Zelle® tag), or any other suitable destination identifying information configured to allow for a transfer of funds from the allocated user portion to a recipient account (e.g., a merchant account, another individual's account). In some instances, if the AUP payment card is a stored value card, the destination can be loading funds onto the AUP payment card, as discussed above.

The bill pay widget 406 includes a bill pay setup link 418 configured to allow the non-account holder to set up a recurring bill payment from the allocated user portion. For example, the non-account holder can provide various bill payment information (e.g., bill amount, recurring bill period) and recipient account information (e.g., account number, routing number) associated with a merchant of goods and/or services (e.g., an internet provider) or other recurring payment recipient. Accordingly, once set up, the provider computing system 102 can automatically transfer funds from the allocated user portion to the merchant (or other recurring payment recipient) to make recurring bill payments on behalf of the non-account holder.

The permissions request button 408 is configured to allow for the non-account holder to request additional capabilities associated with the allocated user portion. For example, the permissions request button 408 can navigate the non-account holder to a separate page where the non-account holder can request any of the various capabilities discussed above (e.g., with respect to the various account option selection boxes 304) via the non-account holder device 106. Accordingly, upon requesting the additional capabilities, the account holder device 104 receives the request (e.g., via a pop-up window, a push notification, a text message) and is able to approve or deny the request for additional capabilities.

The credit report button 410 is configured to allow the non-account holder to selectively report a tracked transaction history associated with the allocated user portion to one or more credit bureaus (e.g., the credit bureau computing system 107), as will be described in detail below.

Referring now to FIG. 5, a flow diagram of a method 500 for tracking and reporting tracked actions associated with an allocated user portion is shown, according to an example embodiment. In some instances, the method 500 is performed or otherwise executed using various components of the computing environment 100.

As shown, the method 500 begins with the provider computing system 102 creating an allocated user portion within an account of an account holder, at step 502, as described above, with respect to the method 200. Once the allocated user portion has been created, as discussed above, the provider computing system 102 then tracks actions taken associated with the allocated user portion, at step 504. The provider institution (e.g., the provider computing system 102) tracks a variety of actions taken by the non-account holder and/or on the non-account holder's behalf with respect to the allocated user portion of the account holder account. For example, in some instances, the provider computing system 102 tracks transactions conducted using the allocated user portion and/or the AUP payment card, a history of deposits made into the allocated user portion by the non-account holder, a bill payment history associated with the allocated user portion, a balance history of the allocated user portion, or any other pertinent information that is relevant for assessing an individual's creditworthiness. In some instances, in the case that the account holder deposits funds into the allocated user portion on the non-account holder's behalf, the account holder can log or submit indications to the provider computing system 102 (e.g., via the account holder device 104) regarding payments (e.g., cash payments) made by the non-account holder to the account holder. Accordingly, the provider institution can additionally track these external transfers of funds between the account holder and the non-account holder.

Accordingly, the provider computing system 102 can establish and build a credit history for the non-account holder without the non-account holder having a formal relationship with the provider institution (e.g., without opening an account with the provider institution). In some instances, the provider computing system 102 can track the various actions taken by the non-account holder and/or on the non-account holder's behalf anonymously. That is, the tracked actions can be tracked and associated with the allocated user portion without the provider institution having any interaction with or information pertaining to the non-account holder generally, and these tracked actions can later be associated with the non-account holder by request for reporting to various credit bureaus, as discussed below.

After tracking the actions taken associated with the allocated user portion for a period of time, the provider computing system 102 then receives a request to report the tracked actions, at step 506. For example, the non-account holder can request that the tracked actions of the allocated user portion be reported to one or more credit bureaus (e.g., the credit bureau computing system 107) by clicking on or otherwise interacting with the credit report button 410. For example, the credit report button 410 is configured to navigate the non-account holder to a separate page where the non-account holder can provide various information necessary for reporting the actions associated with the allocated user portion (e.g., name, address, social security number). Accordingly, upon submitting the request to report the tracked actions, the request is transmitted from the non-account holder device 106 to the provider computing system 102.

Upon receiving the request to report the tracked actions, the provider computing system 102 then associates the tracked actions with the non-account holder, at step 508, and reports the tracked actions, at step 510. For example, in some instances, the provider computing system 102 can report the tracked actions in the form of a credit tradeline that is separate from the remainder of the account holder account and includes all of the tracked actions pertaining to the allocated user portion.

As described above, the non-account holder can choose to have the various actions associated with the allocated user portion tracked anonymously and internally within the provider institution (e.g., by the provider computing system 102) and later associated with the non-account holder's personal information and reported to the credit bureau computing system 107. However, in some instances, the non-account holder can have the tracked actions reported to the credit bureau computing system 107 immediately upon creation of the allocated user portion and continuously throughout the lifetime of the allocated user portion. In this case, the non-account holder would provide the various information necessary for reporting the actions associated with the allocated user portion to the provider computing system 102 upon creation of the allocated user portion.

Below are provided various use cases for the systems and methods described herein. It should be appreciated that the following use cases are provided as examples and are not meant to be limiting.

In one example, an account holder at the provider institution has a friend with a monthly bill associated with a biller that has to be paid online. In this example, the account holder could set up an allocated user portion for the friend (i.e., the non-account holder) to allow for the friend to pay the monthly bill without having to open an account of their own. In this case, the friend could either give cash to the account holder, who would then deposit the cash into the allocated user portion, or the friend could deposit the cash into the allocated user portion themselves. In either case, the friend could then set up the monthly online bill payments to be pulled from the allocated user portion via the bill pay setup link 418 described above, and the provider computing system 102 could automatically transfer funds from the allocated user portion to a biller account associated with the biller based on the bill pay information provided by the non-account holder.

In another example, an account holder has a relative living internationally who needs a U.S. payment instrument for making purchases internationally. In this example, the account holder could similarly set up an allocated user portion for the relative (i.e., the non-account holder) and allow the relative to obtain a AUP payment card associated with the allocated user portion for making payments in U.S. currency abroad without having to set up a U.S. bank account while abroad.

In yet another example, an account holder has a relative that recently immigrated to the U.S., does not have a U.S. bank account, and does not wish to open a U.S. bank account (e.g., in the case the relative will only be in the U.S. for a short period of time). In this example, the account holder could similarly set up an allocated user portion for the relative (i.e., the non-account holder) and allow the relative to use the allocated user portion as a temporary pseudo-account of their own while the relative remains in the country.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f) unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include a general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A computing system comprising:
one or more processing circuits including one or more processors and one or more memories having instructions stored thereon that, when executed, cause the one or more processing circuits to:
receive a request from a first user device of a first user associated with a first account of the first user held by a provider to create an allocated user portion within the first account;
create the allocated user portion within the first account based on the request from the first user device;
generate credentials for a second user configured to allow the second user to temporarily perform one or more actions associated with allocated funds of the allocated user portion within the first account and to disallow the second user from performing actions associated with non-allocated funds within the first account that are outside of the allocated user portion; and
transmit the credentials to one of the first user device of the first user or a second user device of the second user.

2. The computing system of claim 1, wherein the allocated user portion is a partitioned portion of the first account that is designated for use by the second user.

3. The computing system of claim 1, wherein the instructions further cause the one or more processing circuits to:
receive the credentials from the second user device; and
cause the one or more actions associated with the allocated funds to be performed based on receiving the credentials.

4. The computing system of claim 1, wherein the instructions further cause the one or more processing circuits to:
upon receiving the credentials from the second user device, generate a graphical user interface including one or more of an allocated balance, an allocated user portion limit, or a selectable option to set up a recurring payment from the allocated user portion of the first account; and
transmit the graphical user interface to the second user device.

5. The computing system of claim 4, wherein the graphical user interface includes the selectable option and the instructions further cause the one or more processing circuits to:
receive a selection of the selectable option from the second user device;
receive recurring payment information associated with the recurring payment; and
initiate a payment from the allocated user portion to a recipient account held by a recipient based on the recurring payment information.

6. The computing system of claim 1, wherein the instructions further cause the one or more processing circuits to:
track transactions associated with the allocated user portion of the first account separately from other transactions associated with the first account; and
transmit transaction information associated with the allocated user portion to a credit bureau computing system.

7. The computing system of claim 6, wherein when the transactions associated with the allocated user portion are tracked, the transactions are initially tracked without being associated with the second user, and the instructions further cause the one or more processing circuits to:
receive a reporting request from the second user device including an indication of an identity of the second user; and
associate the transaction information with the second user,
wherein the transaction information is transmitted to the credit bureau computing system upon receiving the reporting request and associating the transaction information with the second user.

8. The computing system of claim 1, wherein the request received from the first user device includes one or more of a maximum allocated balance, an allocated user portion time limit, or one or more capabilities to be given to the second user.

9. A computing system comprising:
one or more processing circuits including one or more processors and one or more memories having instructions stored thereon that, when executed, cause the one or more processing circuits to:
create an allocated user portion within a first account of a first user held by a provider;
generate credentials for a second user configured to allow the second user to temporarily perform one or more actions associated with allocated funds of the allocated user portion within the first account and to disallow the second user from performing actions associated with non-allocated funds within the first account that are outside of the allocated user portion; and
cause the one or more actions associated with the allocated funds to be performed based on receiving the credentials from the second user.

10. The computing system of claim 9, wherein the allocated user portion is a partitioned portion of the first account that is designated for use by the second user.

11. The computing system of claim 9, wherein the instructions further cause the one or more processing circuits to:
receive the credentials from a second user device of the second user;
upon receiving the credentials from the second user device, generate a graphical user interface including one or more of an allocated balance, an allocated user portion limit, or a selectable option to set up a recurring payment from the allocated user portion of the first account; and
transmit the graphical user interface to the second user device.

12. The computing system of claim 11, wherein the graphical user interface includes the selectable option and the instructions further cause the one or more processing circuits to:
receive a selection of the selectable option from the second user device;
receive recurring payment information associated with the recurring payment; and
initiate a payment from the allocated user portion to a recipient account held by a recipient based on the recurring payment information.

13. The computing system of claim 12, wherein the instructions further cause the one or more processing circuits to:
track transactions associated with the allocated user portion of the first account separately from other transactions associated with the first account; and
transmit transaction information associated with the allocated user portion to a credit bureau computing system.

14. The computing system of claim 13, wherein when the transactions associated with the allocated user portion are tracked, the transactions are initially tracked without being associated with the second user, and the instructions further cause the one or more processing circuits to:
receive a reporting request from the second user device including an indication of an identity of the second user; and
associate the transaction information with the second user,
wherein the transaction information is transmitted to the credit bureau computing system upon receiving the reporting request and associating the transaction information with the second user.

15. A method comprising:
creating, by a provider computing system associated with a provider, an allocated user portion within a first account of a first user held by the provider;
generating, by the provider computing system, credentials for a second user configured to allow the second user to temporarily perform one or more actions associated with allocated funds of the allocated user portion within the first account while preventing the second user from performing actions associated with non-allocated funds within the first account that are outside of the allocated user portion; and
causing, by the provider computing system, the one or more actions associated with the allocated funds to be performed based on receiving the credentials from the second user.

16. The method of claim 15, wherein the one or more actions comprise one or more of depositing funds into the allocated user portion, setting up a recurring payment from the allocated user portion, and requesting a payment card configured to draw funds from the allocated user portion.

17. The method of claim 15, wherein the allocated user portion is a partitioned portion of the first account that is designated for use by the second user.

18. The method of claim 15, further comprising:
tracking, by the provider computing system, transactions associated with the allocated user portion of the first account separately from other transactions associated with the first account; and
transmitting, by the provider computing system, transaction information associated with the allocated user portion to a credit bureau computing system.

19. The method of claim 18, wherein when the transactions associated with the allocated user portion are tracked, the transactions are initially tracked anonymously, and the method further comprises:
receiving, by the provider computing system, a reporting request from the second user including an indication of an identity of the second user; and
associate the transaction information with the second user,
wherein the transaction information is transmitted to the credit bureau computing system upon receiving the reporting request and associating the transaction information with the second user.

20. The method of claim 15, further comprising receiving, by the provider computing system, a request from a first user device of the first user to create the allocated user portion within the first account, the request including one or more of a maximum allocated balance, an allocated user portion time limit, or one or more capabilities to be given to the second user.
